(19) United States
(12) Patent Application Publication
(10) Pub. No.: US 2014/0053053 A1
(43) Pub. Date: Feb. 20, 2014

(54) Methods and systems for real-time extraction of user-specified information

(71) Applicant: Andrew William Hogue, Prompton Lakes, NJ (US)

(72) Inventor: Andrew William Hogue, Prompton Lakes, NJ (US)

(73) Assignee: Google Inc.

(21) Appl. No.: 11/096,094

(22) Filed: Mar. 31, 2005

(51) Int. Cl. G06F 17/22

(52) U.S. Cl. CPC G06F 17/2247
USPC 715/234

(57) ABSTRACT

Systems and methods for real-time extraction of user-specified information are described. One method described comprises receiving a selection of a portion of a web page, wherein the selection comprises a first set of data; dynamically generating an extraction pattern based at least in part on the selection; and extracting a second set of data from the web page based at least in part on the pattern.

### FIELD OF THE INVENTION

The present invention relates generally to information extraction and, more particularly, to methods and systems for real-time extraction of user-specified information.

### BACKGROUND OF THE INVENTION

Search engines can be used to locate individual documents from a large collection of documents, such as the World Wide Web (WWW), or from documents stored on computers of an intranet. Search engines can compile and organize an index of documents by crawling or reading documents, such as web pages. Generally, the crawling of documents occurs on a regular schedule, e.g., daily or weekly. While the regularly scheduled crawl is sufficient for gathering relatively static data, some of the content on the web is “real-time.”

Real-time data on the web is data that is updated after short intervals. Real-time data is most useful to a user during the interval between scheduled crawls. One example of such data is the current price of a stock. Another example is the current score of a sporting event.

Web sites exist that allow a user to view frequent updates of this real-time data. However, these sites often provide more information than a user is interested in viewing. For example, a typical web page on a sports-oriented web site displays multiple games or includes a variety of content in addition to the content that the user wishes to view, such as advertisements. A user may only wish to view one of these scores or a portion of the displayed page. Also, pages containing real-time data may not automatically refresh.

### SUMMARY

Embodiments of the present invention comprise methods and systems for real-time extraction of user-specified information. One aspect of one embodiment of the present invention comprises receiving a selection of a portion of a web page, wherein the selection comprises a first set of data; dynamically generating an extraction pattern based at least in part on the selection; and extracting a second set of data from the web page based at least in part on the extraction pattern.

This illustrative embodiment is mentioned not to limit or define the invention, but to provide one example to aid understanding thereof. Illustrative embodiments are discussed in the Detailed Description, and further description of the invention is provided there. Advantages offered by the various embodiments of the present invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a block diagram of a system in accordance with one embodiment of the present invention;

FIG. 2 is a screen shot illustrating selection of a portion of a web page in one embodiment of the present invention;

FIG. 3 is a screen shot illustrating the display of the selected portion shown in FIG. 2 in one embodiment of the present invention;

FIG. 4 is a node diagram illustrating a sub-tree of a document object model tree in one embodiment of the present invention;

FIG. 5 is a node diagram illustrating a change between the original information in FIG. 4 and the updated version of the information in one embodiment of the present invention;

FIG. 6 is a node diagram illustrating two types of path labeling in a document object model in one embodiment of the present invention;

FIG. 7 is a flow chart illustrating a method of selecting content in a web page and determining the location of the content in one embodiment of the present invention;

FIG. 8 is a flow chart of a method for using the location to find updated content in one embodiment of the present invention; and

FIG. 9 is a flow chart of a method for using context to verify updated content is associated with a user selection in one embodiment of the present invention.

### DETAILED DESCRIPTION

### Introduction

Embodiments of the present invention comprise methods and systems for real-time extraction of user-specified information. There are multiple embodiments of the present invention. By way of introduction and example, one illustrative embodiment of the present invention provides a method for extracting updated content from a portion of a web page. The content of a web page may be updated frequently, such as content including sports scores and stock quotes. Users of web browsers may desire to view updates of this content without having to view the entire web page and without having to continually refresh the web page. One embodiment of the present invention provides a method that allows a user of a web browser to select a portion of a web page to be separately displayed and periodically updated. The method may be implemented, for example, as an extension to an application, such as the Google browser toolbar application, or integrated in an application, such as an Internet browser application.

In one method according to the present invention, a user of a web browser selects a desired portion of content on a web page and then clicks on a button on the browser toolbar. Clicking the button causes a new display window to open on the user's display that includes only the content selected by the user. The content displayed in the display window is then periodically updated from the web page without any user intervention. To update the displayed content, the method dynamically generates an extraction pattern by which content corresponding to the user's selection is periodically extracted. The extraction pattern, such as an extraction wrapper, can be generated based on the location of the user's selection in the web page structure. The location may be a location in Document Object Model (DOM) tree structure of the web page or may be otherwise determined.

For example, a user can select a baseball box score for an ongoing game on a sports or news-oriented web page and then click on a button on a browser toolbar to indicate that he wants to receive updated displays of this selection. The baseball box score is displayed in a separate display window and an extraction pattern is generated based on the location of the box score in the DOM tree structure of the web page. The extraction pattern is then used to periodically extract the box score data from the web page. The display window is periodically updated using the extracted box score data. In one embodiment, the user can modify preferences related to the display, such as the period between updates.

This introduction is given to introduce the reader to the general subject matter of the application. By no means is the invention limited to such subject matter. Illustrative embodiments are described below.

### System Architecture

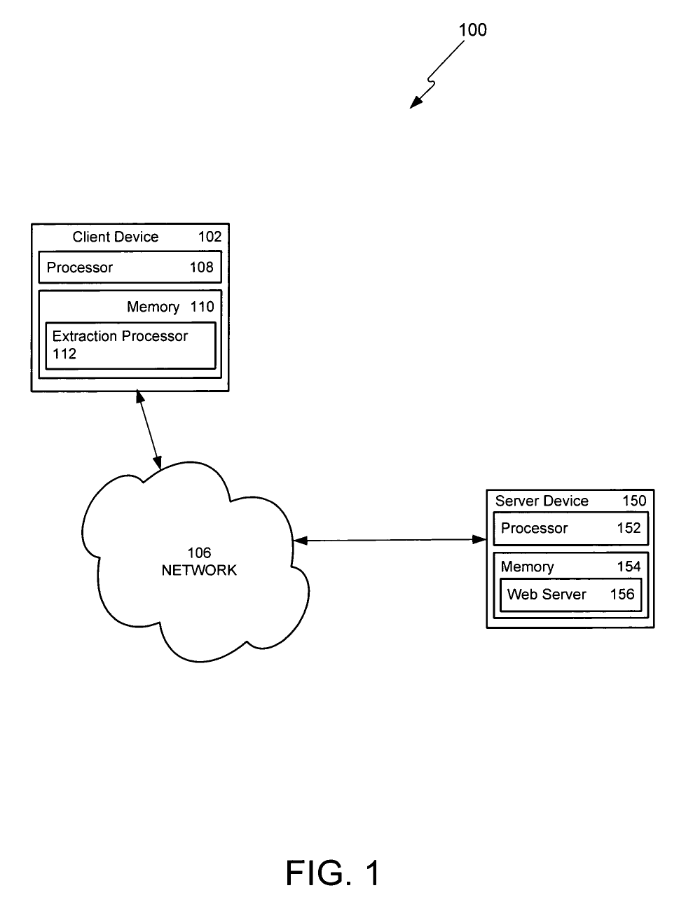

Various systems in accordance with the present invention may be constructed. FIG. 1 is a diagram showing an illustrative system in which illustrative embodiments of the present invention may operate. The present invention may operate, and be embodied in, other systems as well.

Referring now to the drawings in which like numerals indicate like elements throughout the several figures, FIG. 1 is a diagram showing an illustrative environment for implementation of an embodiment of the present invention. The system 100 shown in FIG. 1 comprises a client device 102 in communication with a server device 150 over a network 106. In one embodiment, the network 106 shown comprises the Internet. The network may also comprise an intranet, a Local Area Network (LAN), a telephone network, or a combination of suitable networks. The client device 102 and the server devices 150 may connect to the network 106 through wired, wireless, or optical connections.

In one embodiment, an extraction processor 112 may reside on a client device, such as client device 102, connected to the network 106. When a user specifies a Uniform Resource Locator (URL), the client device 102 issues a request to the web server 156 for a particular web page. The web server 156 responds to the request by sending the web page to the client 102. The web server 156 may provide static and dynamic web pages. The user then selects a portion of the web page containing a data set. The extraction processor 112 determines a pattern for extracting the selected data from the web page and then extracts the data, causing the data to be displayed in a separate display on the client device 102. The extraction processor 112 then periodically requests updated web pages from the web server 156. Upon receiving the updated page, the extraction processor 112 extracts an updated data set from the portion of the updated page corresponding to the user selection and causes the updated data set to be displayed to the user.

### Client Devices

Examples of client device 102 are personal computers, digital assistants, personal digital assistants, cellular phones, mobile phones, smart phones, pagers, digital tablets, laptop computers, Internet appliances, and other processor-based devices. In general, a client device 102 may be any suitable type of processor-based platform that is connected to a network 106 and that interacts with one or more application programs. The client device 102 can contain a processor 108 coupled to a computer readable medium, such as memory 110. Client device 102 may operate on any operating system capable of supporting a browser or browser-enabled application, such as Microsoft® Windows® or Linux. The client device 102 is, for example, a personal computer executing a browser application program such as Microsoft Corporation's Internet Explorer™, Netscape Communication Corporation's Netscape Navigator™, Mozilla Organization's Firefox, Apple Computer, Inc.'s Safari™, Opera Software's Opera Web Browser, and the open source Linux Browser.

### Real-Time Extraction Processor

Memory 110 of the client device 102 contains a real-time information extraction application program, also known as an extraction processor 112. The extraction processor 112 comprises a software application including program code executable by the processor 108 or a hardware application that is configured to facilitate identifying and extracting information from a portion of a web page and displaying or otherwise outputting the original and updated portion of the web page to a user.

The extraction processor 112 illustrated in FIG. 1 may comprise a browser plug-in. A plug-in is a file containing data and/or instructions, which are used to alter, enhance, or extend the operation of a parent application program, such as a browser-enabled application. However, various other implementations may also be utilized. For example, in one embodiment, the extraction functionality is provided by an applet. An applet is a compact application with limited resource requirements that is typically portable between various operating systems. A Java program is one example of an applet.

The extraction processor 112 includes program code for receiving a selection of a portion of a web page from a user. The extraction processor 112 also includes program code for generating an extraction pattern based on the selection by the user. The extraction pattern provides a means for the extraction processor 112 to identify the content of interest to the user when the page is subsequently updated, such as when a sports score or stock price is updated.

The extraction processor 112 also includes code for extracting the original and updated content based on the extraction pattern. After the extraction processor 112 extracts the content, the extraction processor 112 causes the updated content to be displayed in a window on the user's display device. In other embodiments, other means of performing the functions may be implemented. These systems and methods are described in greater detail below.

### Server Devices

The server device 150 shown in FIG. 1 contains a processor 152 coupled to a computer-readable medium, such as memory 154. Server device 150 may also contain a computer readable medium storage device (not shown), such as a magnetic or optical disk storage device. Server device 150, depicted as a single computer system, may be implemented as a network of computer processors. Examples of server device 150 are a server, mainframe computer, networked computer, or other processor-based devices, and similar types of systems and devices. Client processor 108 and server processor 152 can be any of a number of computer processors, as described below, such as processors from Intel Corporation of Santa Clara, Calif. and Motorola Corporation of Schaumburg, Ill.

Such processors may include a microprocessor, an ASIC, and state machines. Such processors include, or may be in communication with computer-readable media, which stores program code or instructions that, when executed by the processor, cause the processor to perform actions. Embodiments of computer-readable media include, but are not limited to, an electronic, optical, magnetic, or other storage or transmission device capable of providing a processor, such as the processor 152 of server device 150, with computer-readable instructions. Other examples of suitable media include, but are not limited to, a floppy disk, CD-ROM, DVD, magnetic disk, memory chip, ROM, RAM, an ASIC, a configured processor, optical media, magnetic tape media, or any other suitable medium from which a computer processor can read instructions. Also, various other forms of computer-readable media may transmit or carry program code or instructions to a computer, including a router, private or public network, or other transmission device or channel, both wired and wireless. The instructions may comprise program code from any computer-programming language, including, for example, C, C++, C#, Visual Basic, Java, Python, Perl, and JavaScript. Program code running on the server device 150 may include web server software, such as the open source Apache Web Server and the Internet Information Server (IIS) from Microsoft Corporation.

It should be noted that the present invention may comprise systems having different architecture than that which is shown in FIG. 1. For example, in some systems according to the present invention, extraction processor 112 may be contained in memory 154. The system 100 shown in FIG. 1 is merely illustrative, and is used to help explain the illustrative systems and processes discussed below.

### Illustrative Web Page Structure

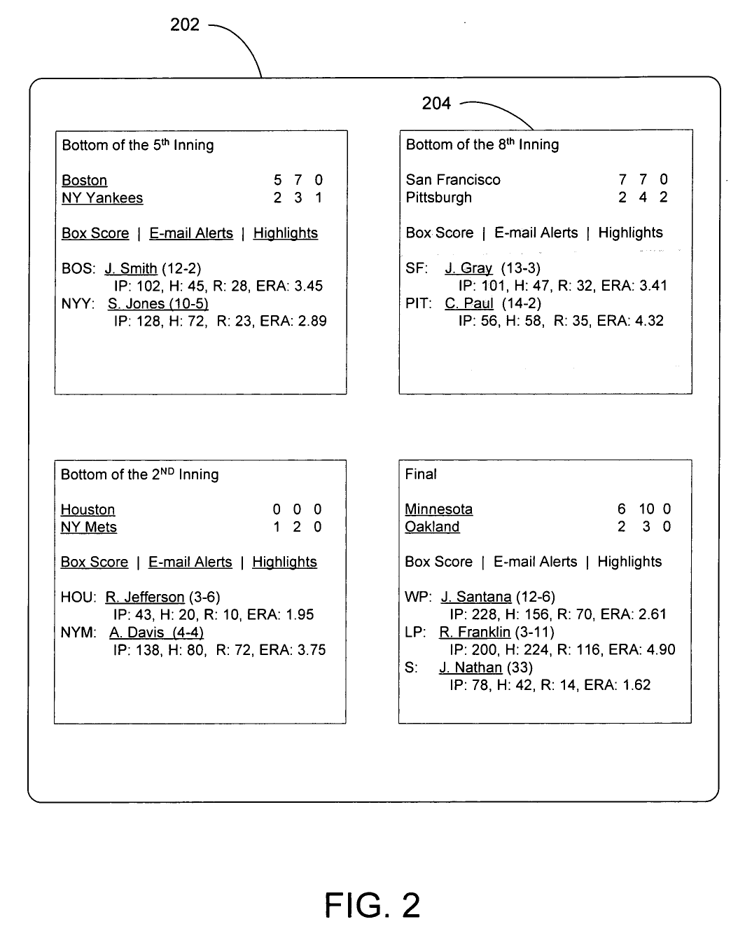

FIG. 2 is a screen shot illustrating selection of a portion of a web page in one embodiment of the present invention. The screen 202 shown in FIG. 2 includes information related to four baseball games. When the user selects a portion of a web page containing content associated with one of the four baseball games, e.g., the window 204 that includes information associated with the San Francisco/Pittsburgh game, the window 204 is highlighted.

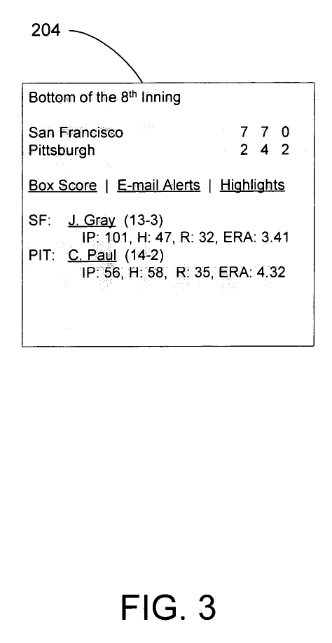

When the user indicates that the extraction processor 112 should extract the selected portion of the web page 202 shown in FIG. 2, a separate display is generated. FIG. 3 is a screen shot illustrating the display of the selected portion shown in FIG. 2 in one embodiment of the present invention. The selected portion of the window shown in FIG. 3 includes all of the content of the window 204. The user may select a smaller portion of the content of window 202, such as, for example, the names of the teams and the scores without information about the pitchers.

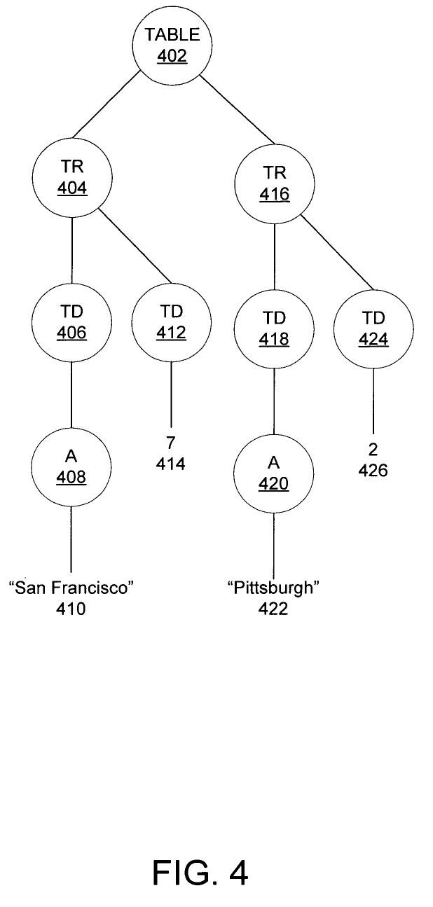

In one embodiment of the present invention, the extraction processor (112) utilizes the document object model (DOM) tree to determine the location of a selection in a web page. When the user selects a portion of a web page, the user is, in effect, selecting a sub-tree of the underlying structure of the web page. FIG. 4 is a node diagram illustrating a sub-tree of the document object model tree in one embodiment of the present invention. The DOM tree shown in FIG. 4 is a subset of the complete DOM tree of the portion of the web page selected by the user as shown in FIG. 3. The DOM tree shown in FIG. 4 includes a table 402. The table 402 includes 2 rows 404, 416.

The first row 404 of the table 402 includes two cells 406, 412. The first cell 406 includes an anchor 408, which is used to create a hyperlink on the rendered page. The text 410 associated with the anchor 408 is “San Francisco.” The second cell 412 of the first row 404 includes text 414, which corresponds to the number of runs scored by San Francisco. In the embodiment shown in FIG. 4, San Francisco has scored 7 runs.

Similarly, the second row 416 of the table 412 includes two cells 418, 424. The first cell 418 includes an anchor 420 with anchor text 420 equal to “Pittsburgh.” And the second cell 424 of the second row 416 includes text corresponding to the number of runs scored by Pittsburgh, in this case, 2.

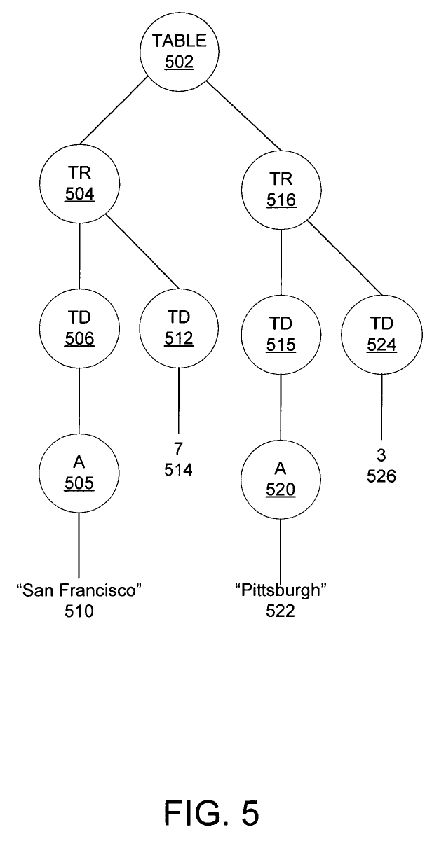

FIG. 5 is a node diagram illustrating a change between the original information in FIG. 4 and the updated version of the information in one embodiment of the present invention. The node diagram shown in FIG. 5 is essentially the same as that shown in FIG. 4. The DOM tree shown in FIG. 5 includes a table 502. The table 502 includes 2 rows 504, 516.

The first row 504 of the table 502 includes two cells 506, 512. The first cell 506 includes an anchor 508, which is used to create a hyperlink on the rendered page. The text 510 associated with the anchor 508 is “San Francisco.” The second cell 512 of the first row 504 includes text 514, which corresponds to the number of runs scored by San Francisco. In the updated information of the embodiment shown in FIG. 5, San Francisco still has 7 runs.

Similarly, the second row 516 of the table 512 includes two cells 518, 524. The first cell 518 includes an anchor 520 with anchor text 520 equal to “Pittsburgh.” And the second cell 524 of the second row 516 includes text corresponding to the number of runs scored by Pittsburgh. In the updated page, Pittsburgh now has 3 runs.

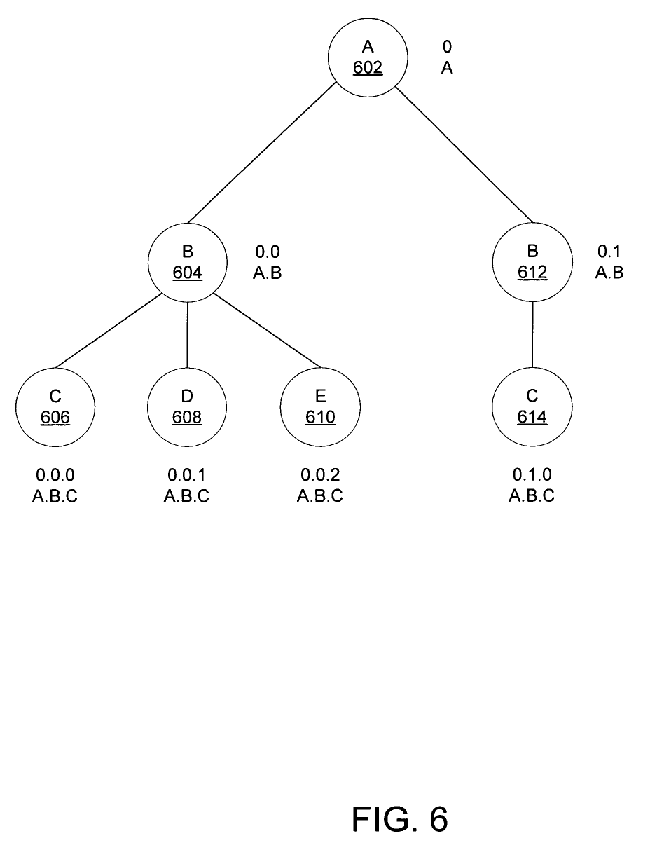

In one embodiment of the present invention, the extraction processor (112) receives a selection of the table 402 shown in FIG. 4. The extraction processor (112) determines where the table 402 begins and ends, for example, by determining where the table begin and end tags (<table> and </table>) occurs in the page. The extraction processor (112) saves the location. Illustrative methods of identifying a specific location in a DOM tree are described below with reference to FIG. 6.

Subsequently, the extraction processor (112) requests an updated version of the page. The extraction processor (112) then retrieves the location of the table 402 from memory. The extraction processor (112) uses the location of the table 402 to find the information contained in table 502.

In one embodiment, the extraction processor (112) utilizes the context around the scores to determine whether of not the updated information is equivalent to the user's selection in the original page. The extraction processor (112) first determines the parent, table cell 524, of the score that has changed 526. The extraction processor (112) then determines the parent, table row 516, of table cell 524. The extraction processor (112) then compares the information contained in table row 516 to the information contained in table row 416. In this case, the two sets of data are very similar, differing by only one attribute—the contents of cell 524 differ from the contents of cell 424. Accordingly, the extraction processor (112) displays the table 502 as the updated equivalent to table 402. In other embodiments, the extraction processor (112) uses other methods to compare the similarity between the original and updated information.

Various methods may be used to determine the location of a selection within a document. For example, in one embodiment, path labeling is used to determine the location. FIG. 6 is a node diagram illustrating two types of path labeling in a document object model (DOM) in one embodiment of the present invention.

The path of a node is the sequence of nodes from the root of a tree to the node v. Various types of paths may be defined. In the embodiment shown in FIG. 6, two types of paths are illustrated. The first type of path illustrated is a sibling path, containing a sibling number for each node w along the path to the node. The second type of path is the tag path, representing the sequence of tag names or labels for each node along the path to the node.

FIG. 6 is labeled with each of these two types of paths. The sibling path begins at the root, A 602, and is equal to “0” for the root node. For node B 604, the sibling path is equal to “0.0”. For node C 606, the sibling path is equal to “0.0.0”. For node D 608, the sibling path is equal to “0.0.1”. And for node E 610, the sibling path is equal to “0.0.2”. For node B 612, the sibling path is “0.1”, and for node 614, the sibling path is “0.1.0”. The sibling path number uniquely identifies each node in the DOM tree.

In contrast, the tag path is equal to “A” for node A 602, “A.B” for node B 604, “A.B.C” for node C 606, “A.B.D” for node D 608, and “A.B.E” for node E 610. The tag path is also “A.B” for node B 612 and “A.B.C” for node C 614.

In one embodiment of the present invention, the extraction processor (112) uses the sibling path to determine the location of a selection. The selection may span multiple nodes. For instance, a selection of the nodes C 606, D 608, and E 610 can be represented by “0.0[1-3] ”. When an updated page is received, the extraction processor (112) then uses the sibling path location stored in memory to locate the information in the updated page.

While the sibling path is useful for finding the same node on multiple pages, the tag path is useful for finding similar nodes on the same page. This is due to the fact that the tag path for multiple nodes on a single page may be the same, such as nodes 606 and 614. In contrast, the sibling path for these two nodes 606, 614 is unique. In another embodiment, the tag path may be used to determine context. For instance, the extraction processor (112) may use the tag path of the stored location to locate other similar nodes and store the content of those nodes in memory. When the updated page is received, the extraction processor (112) locates the updated content using the sibling path and then uses the tag path to validate that the path to the content is the same and to compare stored context with context of the updated information in the updated page. If similar, the extraction processor (112) concludes that the identified information corresponds to the information selected by the user in the original page.

### Illustrative Process for Selection, Extraction Pattern Generation, and Extraction of Data

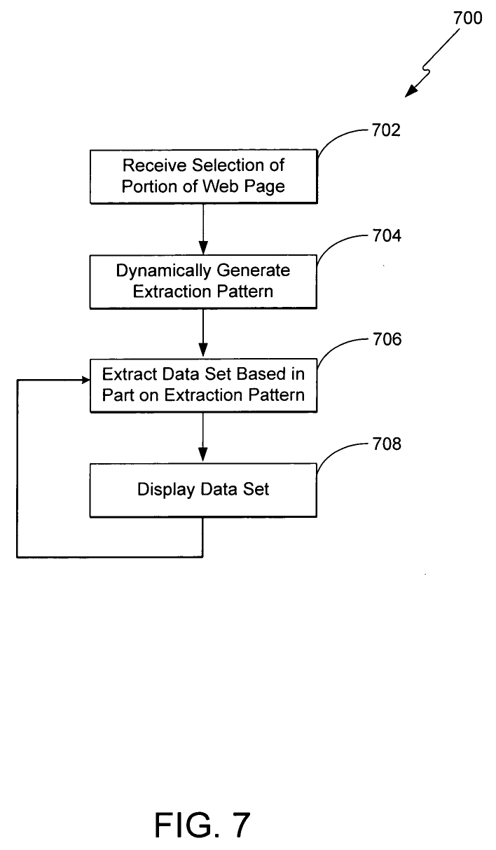

Various methods in accordance with embodiments of the present invention may be carried out. FIG. 7 is a flow chart illustrating a method of selecting content in a web page and determining the location of the content in one embodiment of the present invention. In the embodiment shown, the user indicates a selection of a portion of a web page, for example, by holding down the left mouse button while moving the cursor from the upper-left corner of window 204 to the bottom-right corner of window 204. The extraction processor 112 receives the selection of the portion of the web page 702.

The extraction processor 112 then dynamically generates an extraction pattern for the portion of content selected by the user 704. The extraction pattern may comprise, for example, the location within the web page at which the selection begins and the location at which it ends. In another embodiment, the extraction pattern comprises the location at which the selection begins and an indicator of how much data to extract. For example, the determined location may be the location associated with row in a table, and the extraction pattern may include an indicator specifying that two table rows are included in the selection starting at the determined location.

The extraction pattern may also be referred to as a wrapper. Generating the extraction pattern for information in web documents may also be referred to as wrapper induction. Data on web pages, such as the web page shown in FIG. 2, tend to have a repetitive structure.

This repetitive structure is due to the way in which the web page is created. For example, when the web server 156 receives a request for data, it typically searches a data store for each game to be displayed and data associated with the game, such as the score. For each retrieved record from the data store, the web server 112 typically executes a script, such as a CGI (Common Gateway Interface) script, and uses an HTML (Hypertext Markup Language) template to display the data. Once the HTML template is filled in with data from each of the retrieved records, the completed HTML page is sent to the requestor. In web servers utilizing eXtensible Markup Language (XML), eXtensible Style Sheet Language (XSL) is used to transform XML data into an HTML page.

Since an HTML template is used to construct the portion of the web page containing data of interest to the user, the structure of the web page containing the selected portion should remain relatively constant after each update of the data. Accordingly, by determining the location of the data in the page in which the user selection occurs, the extraction processor (112) is able to determine where to search in the updated page for the corresponding updated content.

Further, the context of the data that is updated is likely to remain the same or similar between updates. For example, in the portion of the web page selected by the user in FIG. 2, the score of the game may change, but the names of the teams will remain the same. By comparing the context of the original page with the context of the updated page, the extraction processor (112) is able to reliably extract information from the updated page that corresponds to that selected by the user on the original page.

Referring still to FIG. 7, the extraction processor (112) next extracts a data set from the web page based on the extraction pattern 706. The data set includes the information about the San Francisco/Pittsburgh game. The extraction processor (112) then causes the data set to be displayed 708. The data set shown includes tags used to format the data for display. In other embodiments, only the data itself (e.g., the names and scores) is included. In the process shown in FIG. 7, the page may be refreshed periodically. Each time the page is refreshed, blocks 706 and 708 are repeated.

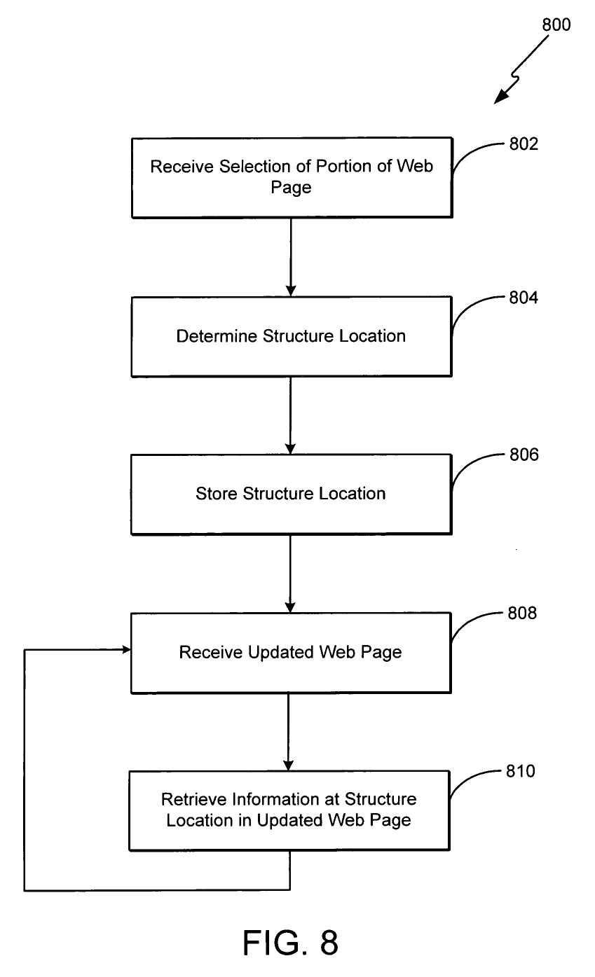

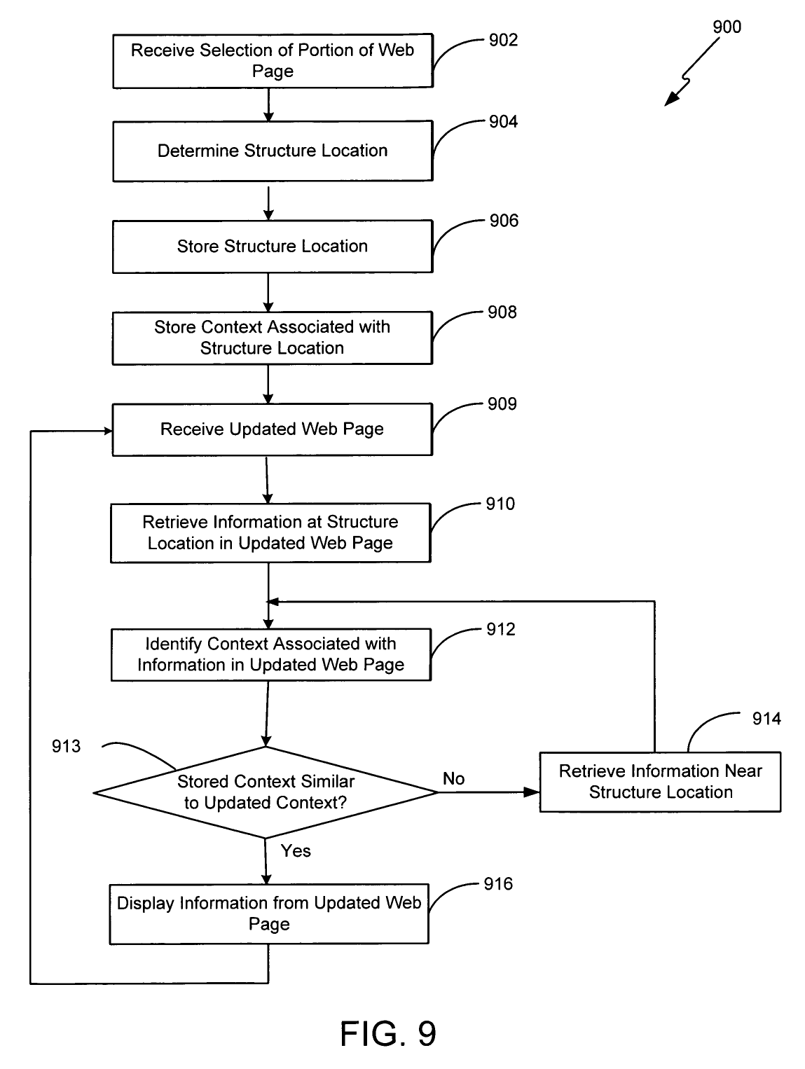

FIGS. 8 and 9 illustrate the process shown in FIG. 7 in greater detail. In one embodiment of the present invention, the extraction processor (112) identifies the location of the selection within the web page. FIG. 8 is a flow chart of a method 800 for using the location to find updated content in one embodiment of the present invention. In the embodiment shown in FIG. 8, the extraction processor (112) receives a selection of a portion of a web page 802. The extraction processor (112) then determines the location of the selected portion within the structure of the web page 804. Methods for determining the location of the selection within the structure of the web page are described in further detail above in relation to FIGS. 4, 5, and 6. One such method comprises mapping the user selection in the DOM tree structure. Once the extraction processor (112) determines the location of the selection, the extraction processor (112) stores the structure location in memory, such as memory (110) 806.

For example, when the user selects the window 204 shown in FIGS. 2 and 3, the extraction processor determines the location of the beginning of the selection. The beginning of the selection may be identified by, for example, the sibling path of the data set. The sibling path provides the point at which the extraction processor 112 will begin extracting information from the updated page. The extraction processor 112 also stores some indicator of where to stop the extraction. For example, in the DOM tree shown in FIG. 4, the extraction processor 112 may store the sibling path of the table 402 and an indicator to select all children of the table 402.

The extraction processor (112) next receives the updated web page 808. The extraction processor (112) may receive the page in various ways. For example, in one embodiment, the extraction processor (112) includes code that causes the program to pause for a specified time period, e.g., five minutes. At the end of the period, the extraction processor (112) executes a Java applet or JavaScript to retrieve data from the web site of the web page in which the user made the original selection. In response to the request, the extraction processor (112) receives the HTML page from the web server (156).

In response to receiving the HTML page, the extraction processor (112) retrieves the structure location from memory (110). The structure location may be, for example, the sibling path to the table 402 shown in FIG. 5. The extraction processor 112 uses the structure location and the indicator of how much of the page to retrieve after the structure location to retrieve information from the updated web page 810. In the process shown in FIG. 8, the page may be refreshed periodically. Each time the page is refreshed, blocks 808 and 810 are repeated.

As discussed above, the information present in the HTML document and represented by the document object model is hierarchical. For example, a user may select subset of a web page including the name of a sports team may include the following:

```
<parentTag>
    <childTag0 id=“txtHomeTeam”>San Francisco</childTag0>
    <childTag1 id=“txtScore”>7</childTag1>
</parentTag>
```

The HTML shown above has five nodes: the root node is parentTag. The root node has two children, childTag0 and childTag1. The node childTag0 has a name, “txtHomeTeam.” The node childTag1 also has a name “txtScore.” The node childTag0 also has a child, the text “San Francisco.” And the node childTag1 has a child, the text “7.” In one embodiment, the extraction processor 112 stores the location of the selection based on the name of the first childTag, “txtHomeTeam.”

The extraction processor 112 then pauses a specified period of time. After pausing, the extraction processor 112 retrieves the updated page. For example, the extraction processor 112 may execute code such as:

URL url=new URL(“http://www.example.com/”);
URLConnection con=url.openConnection( );
InputStream in=con.getInputStream( );

The read method of the InputStream object can then be used to retrieve the text of the updated page. The extraction processor 112 can then search the content of the page and extract updated information. Various other implementations may be used by embodiments of the present invention.

The extraction processor 112 then retrieves the user selection in the updated page based on the name. To retrieve the location of the node childTag0 by name, an extraction processor 112 according to one embodiment of the present invention may execute code similar to the following:

pageLocation=document.getElementById(“txtHomeTeam”);

To then extract the name and score, the extraction processor may execute the following:

teamName = pageLocation.firstChild.nodeValue;
Score = pageLocation.nextSibling.firstChild.nodeValue;

After this code has executed, the value of the teamName variable is equal to “San Francisco” and the value of the Score variable is equal to “7.” The extraction processor 112 can then use this data to update the display window. Alternatively, the extraction processor 112 may simply extract the HTML itself for display in the display window.

Various methods may be implemented to ensure that the correct updated content is displayed to the user. For example, in one embodiment, the context, e.g., content near the updated content, is utilized to ensure that the correct updated content is displayed to the user. FIG. 9 is a flow chart of a method 900 for using context to verify that updated content is associated with a user selection in one embodiment of the present invention. In the embodiment shown in FIG. 9, the extraction processor (112) receives a selection of a portion of a web page 902. As with the method shown in FIG. 8, the extraction processor (112) then determines 904 and stores 906 the structure location associated with the selection.

In the embodiment shown in FIG. 9, the extraction processor (112) next stores context associated with the structure location in a data store 908. The extraction processor (112) may identify context in various ways. For example, in one embodiment, the extraction processor (112) may retrieve content from a structure of the web page that is adjacent to the selected portion of the web page. In another embodiment, the extraction processor (112) identifies the parent node in the web page structure and then uses as context content from siblings of the selected content.

The DOM tree shown in FIGS. 4 and 5 is a sub-set of the data shown in the selected window 204. In one embodiment, the extraction processor stores the information immediately after the score, “Box Score” in the embodiment shown in FIG. 3, and stores “Box Score” and its location with relation to the DOM tree as context.

The extraction processor (112) next receives an updated web page 909. The extraction processor (112) retrieves information in the updated web pages at the structure location previously stored in memory 910. In other words, the extraction processor (112) looks for updated information in the updated web page at the same location that the extraction processor (112) found the original content selected by the user in the original page.

The extraction processor (112) then identifies the context of the information retrieved in the updated web page 912. In the example described above in relation to FIGS. 3 and 4, the extraction processor (112) retrieves information immediately following the score. In this case, the extraction processor (112) finds the text “Box Score.”

If the context of the original information is similar to the updated context 913, then the extraction processor (112) displays the updated information 916. The process illustrated in blocks 909-916 is repeated periodically as the web page is refreshed. If the context is not similar 913, the extraction processor (112) retrieves information that is near the stored structure location 914. Information near the stored structure location may be defined in various ways. For example, the extraction processor (112) may retrieve information that shares the parent of the selected content within the DOM tree or may be adjacent to the selected content within the DOM tree.

The extraction processor (112) then retrieves the context of the newly retrieved information 912 and compares the context of the newly retrieved information with the context of the originally selected information 913. The extraction processor continues repeating these processes until the updated content is found. In the example described above in relation to FIGS. 3 and 4, the context stored with the scores was “Box Score.” The context adjacent to the retrieved information in the DOM tree shown in FIG. 5 is also “Box Score.” Accordingly, the extraction processor (112) determines that the context is similar and the extraction location is correct.

In the embodiment shown in FIG. 9, the context does not have to be precisely the same in the original and updated information. For example, if the San Francisco/Pittsburgh baseball game is completed between the original selection and the time when the updated version is retrieved, the context of the score may change. For instance, the name of the winning team may be highlighted. Highlighting of the name will require an additional or modified tag for the team (e.g., <b>). This change is not substantial; the context of the original score and updated score are, while not precisely the same, similar enough to allow the extraction processor (112) in such an embodiment to cause the updated information to be displayed.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. The method of claim 15, wherein:
the selection is a selection made by a user interaction with the display of the first web page; and
the second web page is an updated version of the first web page.

2. (canceled)

3. The method of claim 1, further comprising outputting the selection by causing a display window comprising the selection to be displayed that includes a display of the first set of data.

4. The method of claim 3, further comprising updating, with the computer processor-based system, the selection on the display window with a second display of the second set of data.

5-7. (canceled)

8. The method of claim 15, wherein determining the path through the first structure includes identifying a name in the first structure.

9. (canceled)

10. The method of claim 15, further comprising extracting the second set of data occurs periodically.

11. The method of claim 1, wherein the second set of data differs at least in part from the first set of data.

12-13. (canceled)

14. The method of claim 1, wherein the second set of data comprises an updated version of the first set of data.

15. A machine-implemented method comprising:
receiving, by a computer processor-based system, a selection of a first region in a display of a first web page, the first web page having a web address, wherein the first region includes a visible display of a first set of data, the first web page having data organized in a first structure;
determining, by the computer processor-based system, a path through the first structure to a location of the first set of data within the first web page;
identifying, by the computer processor-based system, visible content displayed in an adjacent region adjacent to the first region in the display of the first web page;
storing, by the computer processor-based system, the path and the visible content;
extracting, at a later time, from a second web page that is located at the web address where the first web page was previously located, by the computer processor-based system, a second set of data, the second set of data being arranged for display in a second region in a display of the second web page, wherein the extracting includes locating the second set of data in a second structure of the second web page using the stored path, wherein the second web page includes at least some content that is different from content of the first web page; and
verifying the second set of data by comparing the stored visible content with second visible content arranged for display in a region of the display of the second web page adjacent to the second region.

16. The method of claim 15, further comprising causing, with the computer processor-based system, a display window comprising a display of the first set of data to be displayed, wherein the display window excludes display of data from the web page that is outside the first region in the display of the first web page.

17. The method of claim 16, further comprising updating, with the computer processor-based system and in response to extracting and verifying the second set of data, the display window with a display of the second set of data.

18. (canceled)

19. The method of claim 15 wherein:
the selection is received by user interaction with the display of the first web page;
the first structure comprises a document object model tree structure that represents the first web page; and
the determined path identifies the location of the first set of data within the document object model tree structure of the first web page using a sibling path that characterizes a sibling number for each node in the selection along a path to the node.

20. An article comprising one or more tangible computer-readable data storage media on which are encoded program code operable to cause one or more data processing devices to perform operations, the operations comprising:
receiving a user selection of a first region in a display of a first web page, wherein the first region includes a display of a first set of data and the user selection is received via user interaction with the display of the first web page, the first web page having data organized in a first structure;
determining a path through the first structure to a location of the first set of data within the first web page;
identifying visible content displayed in an adjacent region adjacent to the first region in the display of the first web page;
storing the path and the visible content;
extracting, at a later time, from a second web page that is located at the web address where the first web page was previously located, a second set of data, the second set of data being arranged for display in a second region in a display of the second web page, wherein the extracting includes locating the second set of data in a second structure of the second web page using the stored path, wherein the second we page includes at least some content that is different from content of the first web page; and
verifying the second set of data by comparing the stored visible content with second visible content arranged for display in a region of the display of the second web page adjacent to the second region.

21. The article of claim 20, wherein the operations further comprise outputting the first set of data.

22-27. (canceled)

28. A machine-implemented method comprising:
displaying, with a computer processor-based system, for a user, a display of a first version of a web page provided by a web server;
receiving, with the computer processor-based system, from the user, an identification of a region in the display of the first version of the web page that includes a first set of data, the first version of the web page having data organized in a structure;
determining, by the computer processor-based system, a path through the structure that indicates a location of the first set of data within the first version of the web page;
identifying, by the computer processor-based system, visible content located in a second region in the display of the first version of the web page adjacent to the user-identified region;
requesting, with the computer processor-based system, the web page from the web server and receiving a second version of the web page in response;
extracting, with the computer processor-based system, a second set of data configured for display in a region of a display of the second version of the web page that corresponds to the user-identified region in the display of the first version of the web page, wherein extracting the second set of data comprises locating the second set of data, using the determined path, in a second structure by which data in the second version of the web page is organized, and comparing particular visible content in a region of the display of the second version of the web page with the identified visible content, the particular visible content located in a region of the display of the second version of the web page adjacent to the region that includes the second set of data; and
displaying, with the computer processor-based system, for the user, the second set of data in a display window from which other data of the second version of the web page is excluded.

29. The method of claim 28, wherein:
the web page comprises a structured document that includes tagged elements; and
determining the path comprises identifying that a tagged element in the structured document is positioned at the user-identified region.

30. The method of claim 29, wherein:
determining the path further comprises identifying a parent node of the tagged element; and
extracting the second set of data comprises comparing the parent node of the tagged element with a node in the second structure.

31. The method of claim 1, wherein the first structure comprises a plurality of nodes, the selection corresponds to a particular node in the plurality of nodes, and the path through the first structure characterizes a sibling number for each node in the selection along a path to the particular node.

32-33. (canceled)

34. The method of claim 31, wherein an identifier for each node in the plurality of nodes comprises a sibling number.

35. The method of claim 28, further comprising:
again requesting, with the computer processor-based system, the web page from the web server and receiving a third version of the web page in response;
extracting, with the computer processor-based system, a third set of data configured for display in a region of a display of the third version of the web page that corresponds to the user-identified region in the display of the first version of the web page, wherein extracting the third set of data comprises locating the third set of data, using the determined path, in a third structure by which data in the third version of the web page is organized, and comparing second particular visible content in a region of the display of the third version of the web page with the identified visible content, the second particular visible content located in a region of the display of the third version of the web page adjacent to the region that includes the third set of data; and
displaying, with the computer processor-based system, for the user, the third set of data in a display window from which other data of the third version of the web page is excluded.

36. The method of claim 15, wherein each of the first and second structures comprises a document object model tree structure.

37. The method of claim 28, wherein each of the first and second structures comprises a document object model tree structure.
